(19) United States
(12) Patent Application Publication
(10) Pub. No.: US 2005/0007360 A1
(43) Pub. Date: Jan. 13, 2005

(54) Panel display apparatus

(75) Inventor: Yukihiro Matsumoto, Fukuroi-shi (JP)

Correspondence Address: SUGHRUE MION, PLLC, 2100 PENNSYLVANIA AVENUE, N.W., SUITE 800, WASHINGTON, DC, 20037, US

(73) Assignee: PIONEER CORPORATION

(21) Appl. No.: 10/883,683

(22) Filed: Jul. 6, 2004

(30) Foreign Application Priority Data
Jul. 7, 2003 (JP) P2003-192905

(51) Int. Cl. G09G 5/00

(52) U.S. Cl. 345/204

(57) ABSTRACT

A panel display apparatus comprises a luminance control section for multiplying respective input pixel signals by coefficients corresponding to respective pixels so as to correct dispersion in luminance level between pixels on a plasma display panel caused when display based on signals having the same luminance level is executed, and for thereby generating corrected pixel data. The corrected pixel data is converted into address data in a display data creation section. The address data is supplied to an address driver via a frame memory.

### BACKGROUND OF THE INVENTION

1. Field of the Invention

The present invention relates to a panel display apparatus including a panel drive section for driving a display panel, and a control section for outputting a control signal to the panel drive section in order to control the panel drive section.

2. Description of the Related Art

A panel display apparatus is known which includes a panel drive section for driving a plasma display panel, and a control section for outputting input pixel signals corresponding to respective pixels of the plasma display panel to the panel drive section. In such a panel display apparatus, the input pixel signals to be supplied to the drive section are corrected based on an average luminance level, and thereby light emission luminance is controlled (see, for example, Japanese Patent Application Laid-Open No. H11-24631). Japanese Patent Application Laid-Open No. H11-24631 corresponds to U.S. Pat. No. 6,278,436 and EP0888004. U.S. Pat. No. 6,278,436 to Pioneer Electronic Corporation is hereby incorporated by reference.

In a plasma display panel, however, a phenomenon that the actual light emission luminance differs according to a region on the screen occurs. For example, when light is emitted on the whole surface of the panel by a whole white display signal, experiments conducted by the present inventor show that the upper region of the panel having relatively high temperature becomes dark whereas the lower region of the panel having relatively low temperatures becomes bright. Thus, in a display panel, such as a plasma display panel, there is a general tendency to nonuniform temperature distribution in the vertical direction, and luminance variation occurs. It is considered that this is caused by a rise of hot air generated by heat generation in a display panel.

### SUMMARY OF THE INVENTION

The present invention has been achieved in order to solve the above-described issue. An object of the present invention is to provide a panel display apparatus that can reduce a luminance variation in a display screen of display panel.

The invention according to claim 1 relates to a panel display apparatus, comprising a panel drive section for driving a display panel, and a control section for outputting a control signal for controlling the panel drive section toward the panel drive section,
the control section comprising a luminance correction device which multiplies respective input pixel signals by coefficients corresponding to respective pixels so as to correct dispersion in luminance level between pixels on the display panel caused when display based on signals having the same luminance level is executed, and which thereby generates corrected pixel data,
wherein the control section outputs the control signal based on the corrected pixel data toward the panel drive section.

### BRIEF DESCRIPTION OF THE DRAWINGS

FIG. 1 is a block diagram showing a configuration of a panel display apparatus;

FIG. 2 is a block diagram showing a configuration of a luminance control section;

FIG. 3 is a diagram showing attachment positions of temperature sensors attached to a display panel; and

FIG. 4 is a diagram showing one field in light emission operation of a plasma display panel.

### DESCRIPTION OF THE PREFERRED EMBODIMENTS

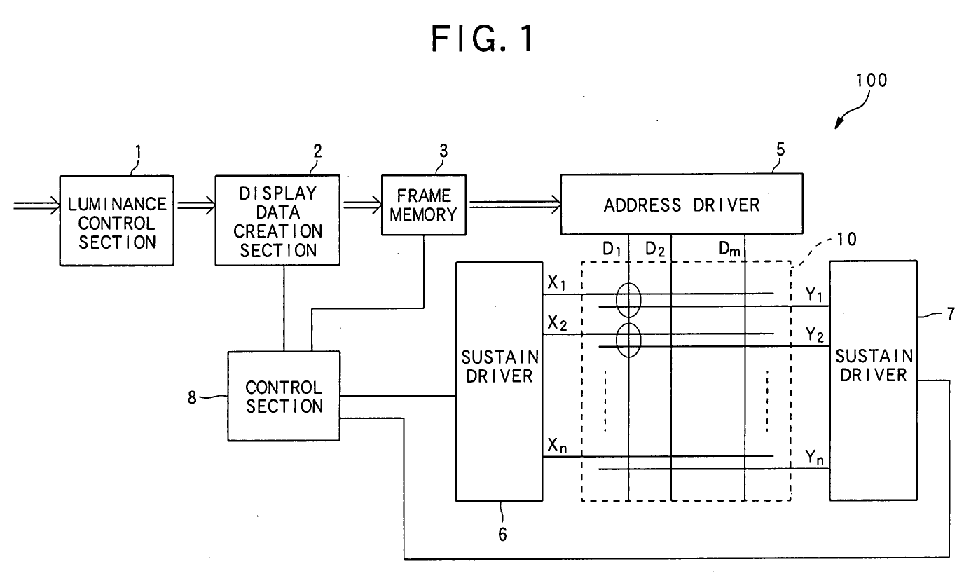

Hereafter, an embodiment of a panel display apparatus according to the present invention will be described with reference to FIGS. 1 to 4.

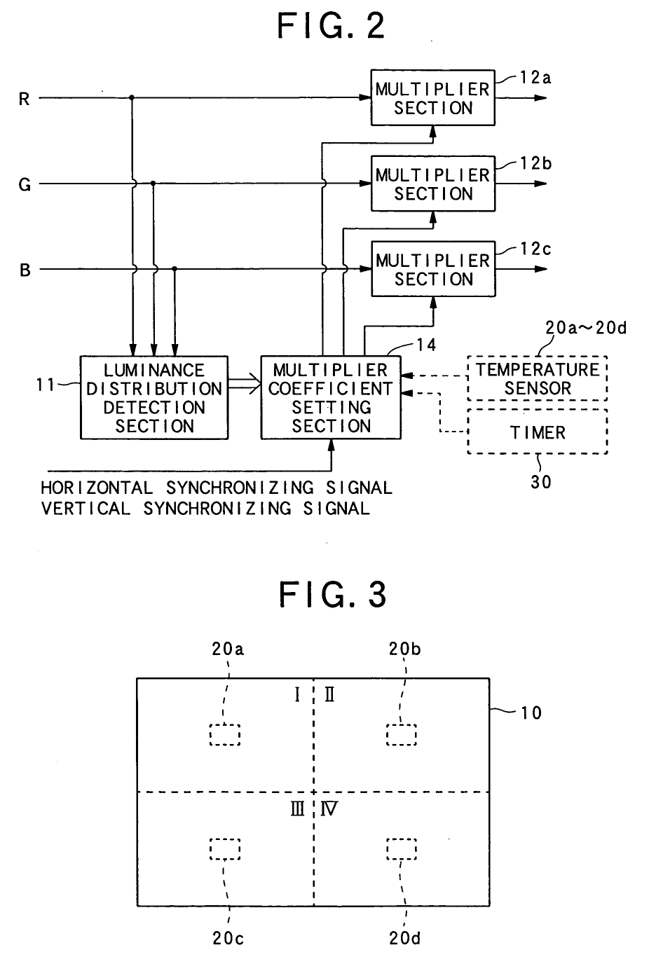

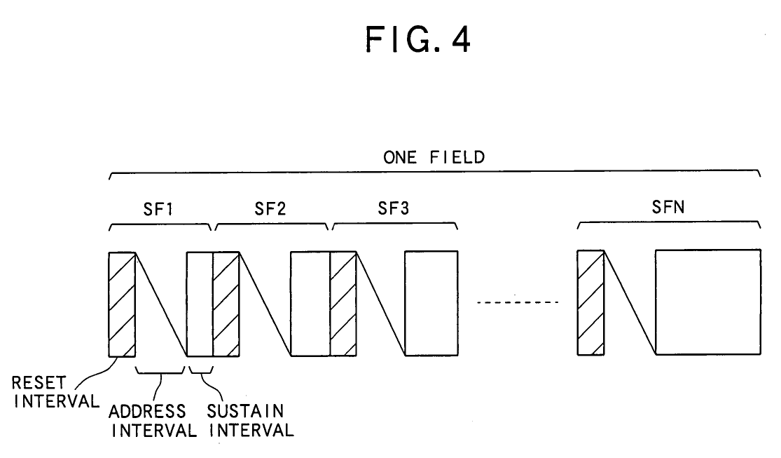

FIG. 1 is a block diagram showing a configuration of a panel display apparatus according to an embodiment. FIG. 2 is a block diagram showing a configuration of a luminance control section. FIG. 3 is a diagram showing attachment positions of temperature sensors attached to a display panel. FIG. 4 is a diagram showing a structure of one field.

As shown in FIG. 1, a panel display apparatus 100 of the present embodiment includes a luminance control section 1 for correcting input pixel signals and generating corrected pixel data, a display data creation section 2 for creating address data based on the corrected pixel data output from the luminance control section 1, a frame memory 3 for successively storing the address data output from the display data creation section 2 by taking a frame as unit, an address driver 5 for applying data pulses to column electrodes D1 to Dm of a plasma display panel 10 in accordance with the address data read out from the frame memory 3, a sustain driver 6 for driving row electrodes X1 to Xn, a sustain driver 7 for driving row electrodes Y1 to Yn, and a control section 8 for controlling the display data creation section 2, the frame memory 3, the sustain driver 6 and the sustain driver 7.

As shown in FIG. 2, the luminance control section 1 includes a luminance distribution detection section 11 for receiving input pixel signals of respective colors (R, G and B) and detecting luminance distribution on a screen of the plasma display panel 10, multiplier sections 12a to 12c for multiplying the input pixel signals of respective colors (R, G and B) by predetermined coefficients, and a multiplier coefficient setting section 14 for setting the multiplier coefficients to be used in the multiplier sections 12a to 12c.

The multiplier coefficient setting section 14 includes a memory (ROM) for storing a multiplier coefficient table created by previously measuring luminance variation at the time of the whole white display on the plasma display panel 10, i.e., when display based on signals of the same luminance levels is executed. Multiplier coefficients for correcting the luminance variation at the time of whole white display and thereby obtaining uniform luminance over the whole display screen are stored in the multiplier coefficient table. More specifically, when the whole white display is executed by the input pixel signals given before correction, the temperature rise becomes greater in the upper region of the screen of the plasma display panel 10 as compared with the lower region thereof, and consequently the luminance in the upper region falls. In the multiplier coefficient table, therefore, the multiplier coefficients in the upper region of the screen of the plasma display panel 10 are set equal to greater values as compared with the lower region thereof. As a result, uniform luminance is obtained over the whole screen of the plasma display panel 10 at the time of the whole white display. For example, it is also possible to divide the screen of the plasma display panel 10 into a plurality of regions in the vertical direction and store multiplier coefficients corresponding to respective regions in the multiplier coefficient table.

As appreciated from the fact that information detected in the luminance distribution detection section 11 is input to the multiplier coefficient setting section 14 in FIG. 2, it is possible to reflect the luminance distribution detected in the luminance distribution detection section 11 into the multiplier coefficients to be selected in the multiplier coefficient setting section 14. In other words, multiplier coefficients can be set in the multiplier coefficient setting section 14, taking into consideration both the luminance distribution state and the luminance variation obtained at the time of the whole white display. For example, a plurality of tables according to average luminance may also be prepared every pertinent region so as to switch the selected multiplier coefficients according to the average luminance of the pertinent region. Furthermore, a plurality of tables according to the luminance distribution or a pattern may also be prepared so as to correct the multiplier coefficients according to the luminance distribution detected in the luminance distribution detection section 11 or a pattern indicated by the input image data.

Operation of the panel display apparatus 100 will now be described.

When input image data is input to the luminance control section 1, luminance distribution on the screen based on the input image data is detected in the luminance distribution detection section 11, and detected information is supplied to the multiplier coefficient setting section 14. As described above, multiplier coefficients are selected in the multiplier coefficient setting section 14 with reference to the multiplier coefficient table. By executing the multiplication processing, the input image data is corrected, and is output as corrected pixel data. The corrected pixel data is converted into address data in the display data creation section 2. Resultant address data are written into the frame memory 3 one after another by taking a frame as unit. In addition, the address data are read from the frame memory 3 one after another, and are output toward the address driver 5. In this way, address data created based on the corrected pixel data are supplied to the address driver 5.

Predetermined drive pulses described later are supplied to the plasma display panel 10 from the address driver 5 supplied with the corrected pixel data and the sustain drivers 6 and 7 controlled by the control section 8. In this way, a predetermined image according to the corrected pixel data is displayed on the plasma display panel 10.

Light emission operation of the plasma display panel 10 will now be described.

FIG. 4 is a diagram showing one field in the light emission operation of the plasma display panel 10.

One field serving as an interval for driving the plasma display panel 10 includes a plurality of subfields SF1 to SFN. As shown in FIG. 4, each subfield includes an address interval for selecting discharge cells to be lit, and a sustain interval for causing the cells selected in the address interval to continue to be lit for a predetermined time. In a head portion of SF1, which is a first subfield, a reset interval for resetting the lighting state in an immediately preceding field is provided. In this reset interval, all cells are reset to light emitting cells (cells having wall charges formed therein) or all cells are reset to light unemitting cells (cells having no wall charges formed therein). In the former case, predetermined cells are switched to light unemitting cells in a subsequent address interval. In the latter case, predetermined cells are switched to light emitting cells in the subsequent address interval. The sustain interval is lengthened stepwise in the order of the subfields SF1 to SFN. By changing the number of subfields during which cells continue to be lit, predetermined gradation display is made possible.

In the address interval in each of subfields shown in FIG. 4, address scanning is conducted every line. In other words, at the same time that a scan pulse is applied to the row electrode Y1 forming a first line by the sustain driver 7, a data pulse DP1 according to address data corresponding to cells on the first line is applied to the column electrodes D1 to Dm by the address driver 5. Subsequently, at the same time that a scan pulse is applied to the row electrode Y2 forming a second line by the sustain driver 7, a data pulse DP2 according to address data corresponding to cells on the second line is applied to the column electrodes D1 to Dm by the address driver 5. As for a third line and subsequent lines as well, a scan pulse and a data pulse D3 are simultaneously applied. Finally, at the same time that a scan pulse is applied to the row electrode Yn forming an nth line by the sustain driver 7, a data pulse DPn according to address data corresponding to cells on the nth line is applied to the column electrodes D1 to Dm by the address driver 5. In the address interval, predetermined cells are switched from light emitting cells to light unemitting cells, or switched from light unemitting cells to light emitting cells, as described above.

When the address scan is thus finished, every cell in the subfield has been set to either a light emitting cell or a light unemitting cell. Each time a sustain pulse is applied in the subsequent sustain interval, only the light emitting cells repeat light emission. In the sustain interval, an X sustain pulse and a Y sustain pulse are repetitively applied to the row electrodes X1 to Xn and the row electrodes Y1 to Yn at predetermined timing by the sustain driver 6 and the sustain driver 7, respectively, as shown in FIG. 4. The final subfield SFN includes an erase interval for setting all cells to light unemitting cells by applying predetermined pulses from the sustain driver 6 and the sustain driver 7.

In the panel display apparatus in the present embodiment, the input pixel signals are corrected in the multiplier sections 12a to 12c, as described above. As compared with the case of executing light emission operation based on image data before correction, the number of sustain pulses in the sustain interval is changed by the correction, and consequently, the light emission luminance is corrected.

If the plasma display panel 10 is, for example, vertically reversed and used, multiplier coefficients to be used are nearly vertically reversed. If such a use method is supposed, therefore, it is also possible to arrange to prepare a different multiplier coefficient table created by previously measuring the luminance variation for the whole white display when the plasma display panel 10 is reversed in the vertical direction, and use the different table usable according to user's indication or the like.

Different Embodiment

In the above embodiment, multiplier coefficients are acquired with reference to a multiplier coefficient table created by previous measurement. Alternatively, it is also possible to provide temperature sensors 20a to 20d, as shown in FIG. 2 and FIG. 3, and set the multiplier coefficients based on the temperature detected by the temperature sensors 20a to 20d.

FIG. 3 is a diagram showing disposition positions of the temperature sensors. In the example shown in FIG. 3, four temperature sensors 20a to 20d are attached to the reverse face (opposite face to the display surface) of the plasma display panel 10. As shown in FIG. 3, the temperature sensor 20a is attached to a first region (I), which is an upper left region of the plasma display panel 10. The temperature sensor 20b is attached to a second region (II), which is an upper right region of the plasma display panel 10. The temperature sensor 20c is attached to a third region (III), which is a lower left region of the plasma display panel 10. The temperature sensor 20d is attached to a fourth region (IV), which is a lower right region of the plasma display panel 10. In this way, the screen of the plasma display panel 10 is bisected in both the longitudinal direction and the lateral direction, i.e., the screen of the plasma display panel 10 is divided into four regions. The temperature sensors 20a to 20d are disposed in the four regions, respectively.

As shown in FIG. 2, temperatures in the first to fourth regions detected respectively by the temperature sensors 20a to 20 dare supplied to the multiplier coefficient setting section 14. In the multiplier coefficient setting section 14, multiplier coefficients in the corresponding regions are set according to the detected temperatures. For example, if the temperatures of the first region and the second region are higher than those of the third region and the fourth region, multiplier coefficients corresponding to the first region and the second region are set so as to become higher. As a result, display having high uniformity can be realized over the entire screen of the plasma display panel 10. In such a configuration, the input pixel signals can be corrected based on the actual temperature distribution. Therefore, the temperature distribution can be grasped irrespective of the environment in which the plasma display panel 10 is disposed and irrespective of the use situation. As a result, appropriate correction can be executed in real time.

The number of regions obtained by dividing the plasma display panel is not limited to that in the example shown in FIG. 3.

Furthermore, as shown in FIG. 2, it is also possible to provide a timer 30 for measuring the use time or the like of the plasma display panel 10, and set the multiplier coefficients based on information supplied from the timer 30. For example, it is also possible to measure total use time of the plasma display panel 10 by using the timer 30, and change values of the set multiplier coefficients according to the total use time so as to correct luminance variation expected based on the total use time. Alternatively, it is possible to measure accumulated light emission time in each region by using the timer 30, and change values of the set multiplier coefficients according to the accumulated light emission time so as to correct a luminance change expected based on the accumulated light emission time. In these cases, for example, a plurality of multiplier coefficient tables may be prepared so as to be associated with the total use time of the plasma display panel 10 or the accumulated light emission time in respective regions. If the timer 30 is used, correction in which the change in time of the plasma display panel 10 is taken into consideration can be executed, and consequently a display image that is excellent in luminance uniformity over long time can be obtained.

As heretofore described, in the above-described embodiment, the panel display apparatus includes the luminance control section 1 for multiplying respective input pixel signals by coefficients corresponding to respective pixels so as to correct dispersion in luminance level between pixels on the plasma display panel 10 caused when display based on signals having the same luminance level is executed, and thereby generating corrected pixel data. Therefore, luminance variation in the display screen of the plasma display panel 10 can be reduced efficiently.

In the above embodiments and the claims, the luminance control section 1, the display data creation section 2, the frame memory 3, and the control section 8 correspond to “a control section”. The luminance control section 1 corresponds to “a luminance correction device”. The temperature sensors 20a to 20d correspond to “temperature sensors”.

In the above embodiments, a panel display apparatus for driving a plasma display panel has been described. However, a panel display apparatus according to the present invention can be widely applied to panel display apparatuses for driving various display panels, such as a liquid crystal display panel and an EL display panel other than a plasma display apparatus.

It should be understood that various alternatives to the embodiments of the invention described herein may be employed in practicing the invention. Thus, it is intended that the following claims define the scope of the invention and that methods and structures within the scope of these claims and their equivalents be covered thereby.

The entire disclosure of Japanese Patent Application No. 2003-192905 filed on Jul. 7, 2003 including the specification, claims, drawings and abstract is incorporated herein by reference in its entirety.

1. A panel display apparatus, comprising a panel drive section for driving a display panel, and a control section for outputting a control signal for controlling the panel drive section toward the panel drive section,
the control section comprising a luminance correction device which multiplies respective input pixel signals by coefficients corresponding to respective pixels so as to correct dispersion in luminance level between pixels on the display panel caused when display based on signals having the same luminance level is executed, and which thereby generates corrected pixel data,
wherein the control section outputs the control signal based on the corrected pixel data toward the panel drive section.

2. A panel display apparatus according to claim 1, wherein the luminance correction device generates the corrected pixel data by correcting each of the input pixel signals by using coefficients based on temperature distribution of the display panel.

3. A panel display apparatus according to claim 1, wherein the luminance correction device generates the corrected pixel data by correcting each of the input pixel signals by using coefficients based on use time of the display panel.

4. A panel display apparatus according to claim 1, wherein the luminance correction device generates the corrected pixel data by correcting each of the input pixel signals by using coefficients based on accumulated light emission time of the display panel.

5. A panel display apparatus according to claim 1, wherein the luminance correction device generates the corrected pixel data by correcting each of the input pixel signals by using coefficients based on luminance distribution of the input pixel data.

6. A panel display apparatus according to claim 1, further comprising temperature sensors disposed so as to correspond to a plurality of divisional regions of the display panel,
wherein the luminance correction device generates the corrected pixel data by correcting each of the input pixel signals corresponding to the respective divisional regions by using coefficients based on temperatures of the divisional regions detected by the temperature sensors.
